(19) United States
(12) Patent Application Publication
(10) Pub. No.: US 2025/0305720 A1
(43) Pub. Date: Oct. 2, 2025

(54) FAN MOUNTED AIR FILTER DEVICE

(71) Applicant: John Mc Craney, Lansing, IL (US)

(72) Inventor: John Mc Craney, Lansing, IL (US)

(21) Appl. No.: 18/618,874

(22) Filed: Mar. 27, 2024

(51) Int. Cl. F24F 13/28; B01D 46/00; F24F 8/192

(52) U.S. Cl. CPC F24F 13/28; B01D 46/0005; B01D 46/0032; F24F 8/192

(57) ABSTRACT

A fan mounted air filter device for filtering air blown by a fan includes an electrostatic filter that has a frame and a screen surrounded by the frame. The frame has a rectangular shape to conform to the shape of a box fan. The screen is comprised of an electrically charged material to attract particles suspended in the air onto the screen thereby removing the particles from the air. A pair of brackets is each coupled to the frame and a pair of mounts is each attached to the frame. Each of the pair of mounts releasably engages the box fan for retaining the electrostatic filter on the box fan. An air filter is slidable into each of the pair of brackets to filter particles from the air being blown by the box fan which are too small to be captured by the electrostatic filter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to air filter devices and more particularly pertains to a new air filter device for filtering air blown by a fan. The device includes an electrostatic filter that is mountable to a box fan. The device includes a pair of brackets each attached to the electrostatic filter and a pair of mounts each attached to the electrostatic filter and each of the mounts engages the box fan. The device includes an air filter that is slidable into the pair of brackets on the electrostatic filter.

### (2) Description of Related Art Including Information Disclosed Under 37 CFR 1.97 and 1.98

The prior art relates to air filter devices including a variety of air filter devices that each at least includes an air filter that is attachable to a cage of a fan and a plurality of straps, each attached to the air filter, which attach to the cage for retaining the air filter on the cage and a variety of air filter frame devices that are each attachable to a cage of an air filter for slidably receiving an air filter. In no instance does the prior art disclose an air filter device that includes an electrostatic filter that includes mounts to engage a cage of a fan and a pair of brackets attached to the electrostatic filter and an air filter that is slidable into the pair of brackets.

### BRIEF SUMMARY OF THE INVENTION

An embodiment of the disclosure meets the needs presented above by generally comprising an electrostatic filter that has a frame and a screen surrounded by the frame. The frame has a rectangular shape to conform to the shape of a box fan. The screen is comprised of an electrically charged material to attract particles suspended in the air onto the screen thereby removing the particles from the air. A pair of brackets is each coupled to the frame and a pair of mounts is each attached to the frame. Each of the pair of mounts releasably engages the box fan for retaining the electrostatic filter on the box fan. An air filter is slidable into each of the pair of brackets to filter particles from the air being blown by the box fan which are too small to be captured by the electrostatic filter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a fan mounted air filter device according to an embodiment of the disclosure.

FIG. 2 is a back perspective view of an electrostatic air filter of an embodiment of the disclosure.

FIG. 3 is a back view of an electrostatic air filter of an embodiment of the disclosure.

FIG. 4 is a right side view of an electrostatic air filter of an embodiment of the disclosure.

FIG. 5 is a back perspective view of an electrostatic air filter of an embodiment of the disclosure.

FIG. 6 is an exploded in-use view of an embodiment of the disclosure.

FIG. 7 is a back perspective view of an embodiment of the disclosure showing an electrostatic air filter being elongated.

FIG. 8 is a front perspective view of an embodiment of the disclosure showing an electrostatic air filter being elongated.

FIG. 9 is an exploded in-use view of an embodiment of the disclosure showing an electrostatic air filter being elongated.

FIG. 10 is a back perspective view of an alternative embodiment of the disclosure.

FIG. 11 is a front perspective view of an alternative embodiment of the disclosure.

FIG. 12 is an exploded perspective view of an alternative embodiment of the disclosure.

FIG. 13 is an exploded in-use view of an alternative embodiment of the disclosure.

### DETAILED DESCRIPTION OF THE INVENTION

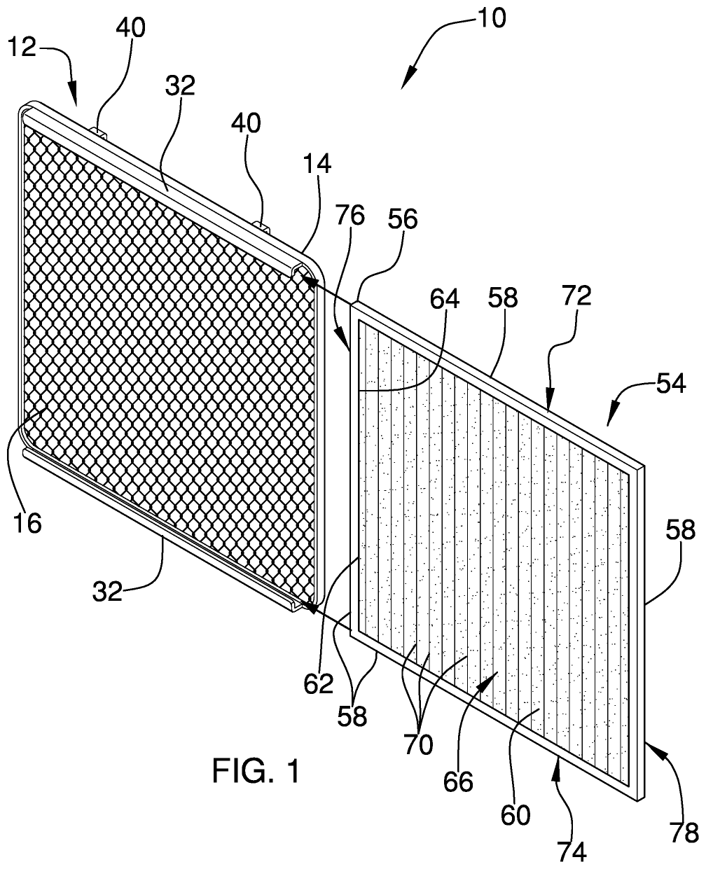

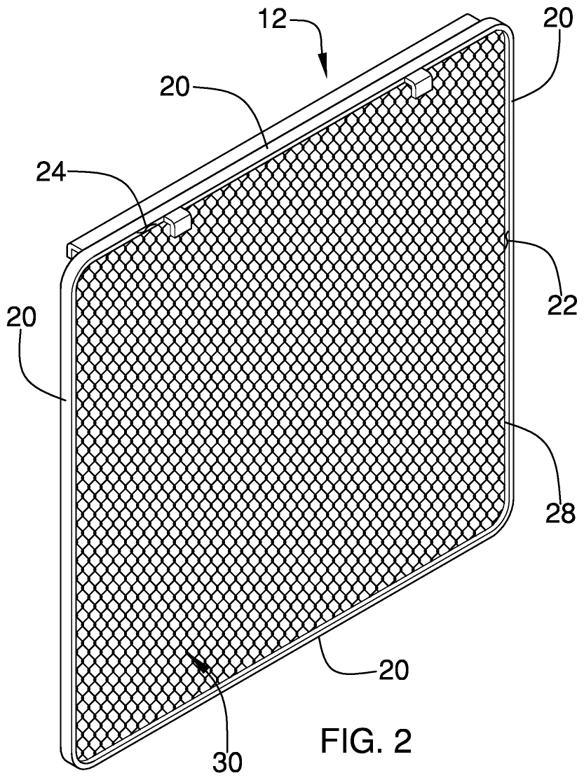

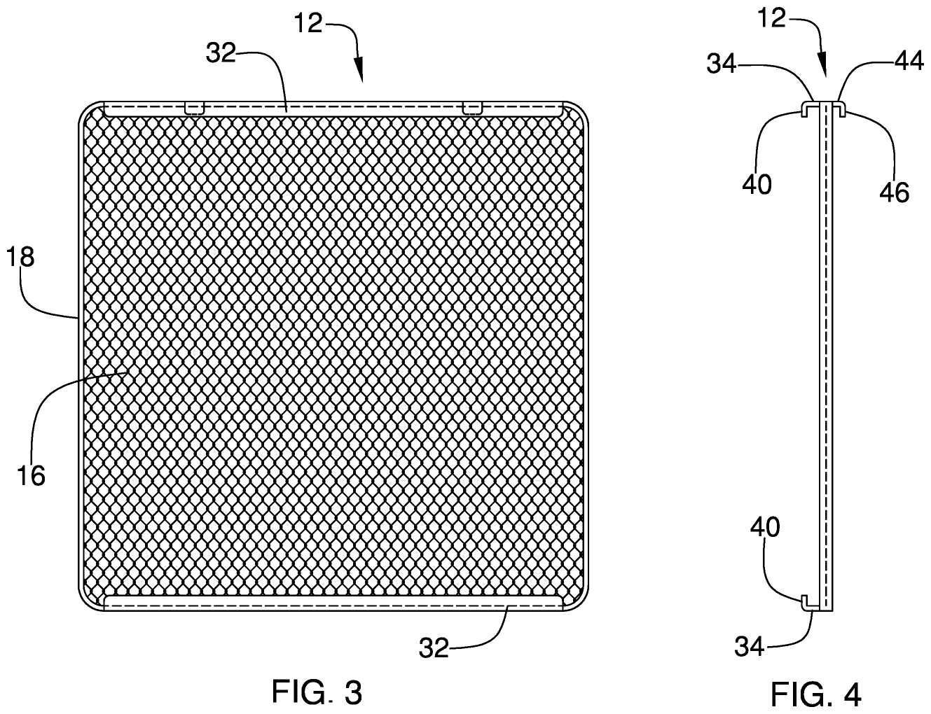

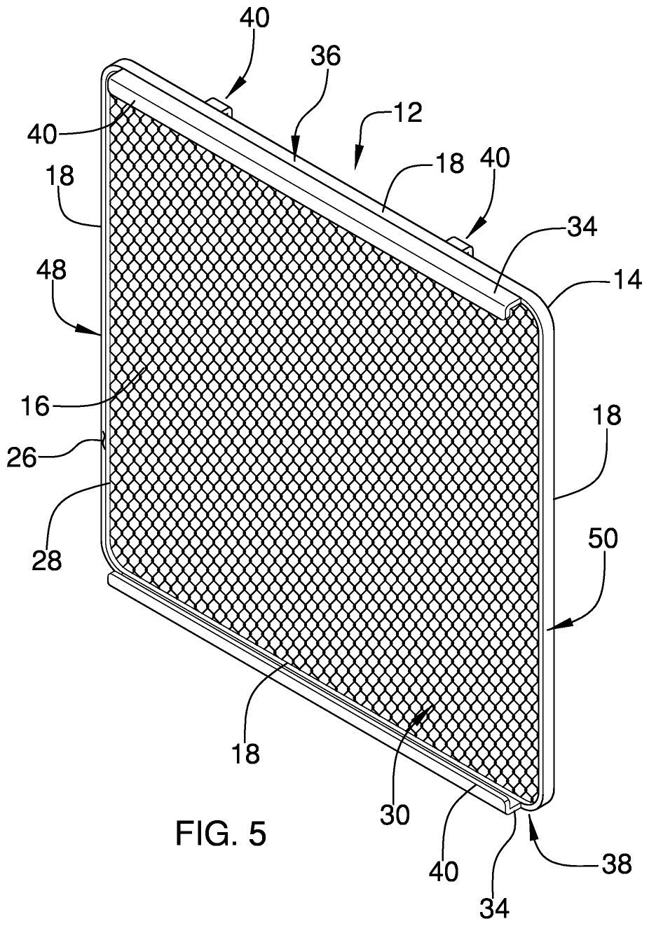

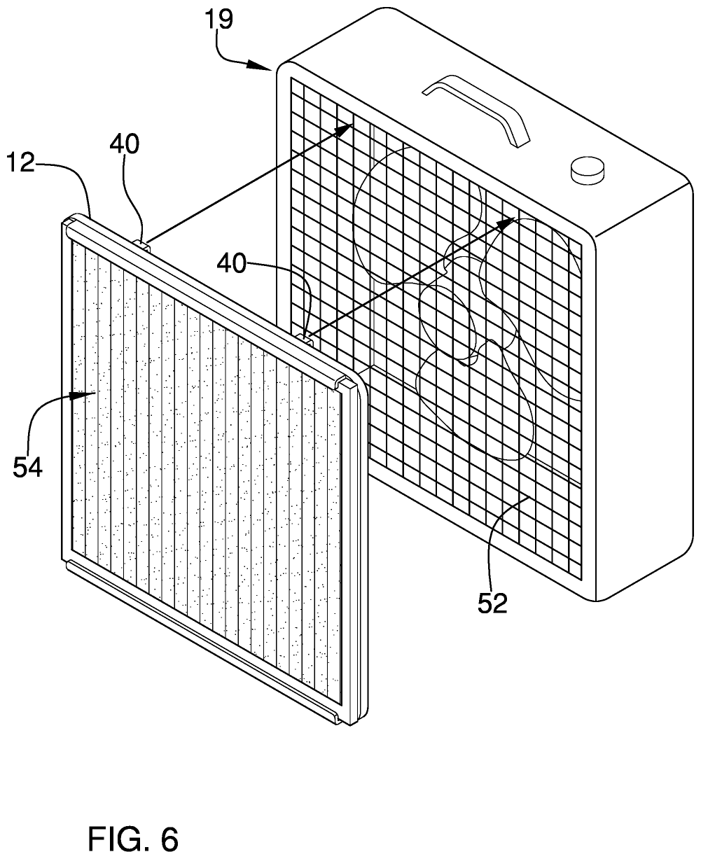

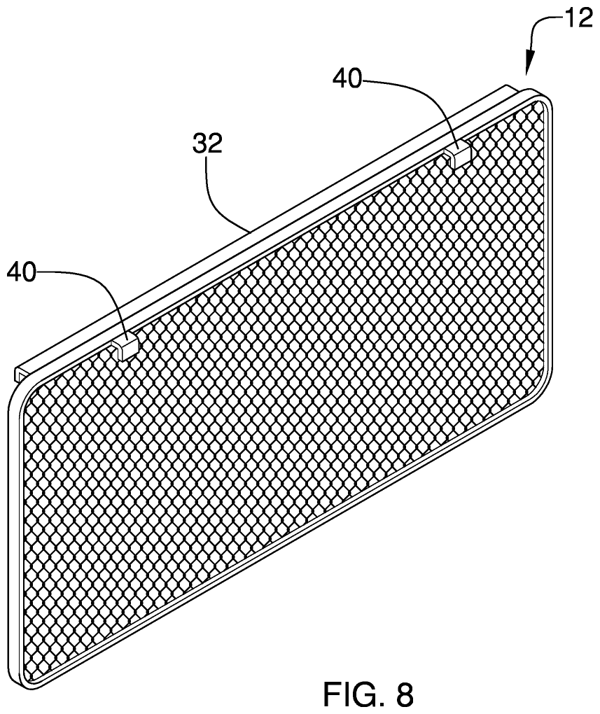

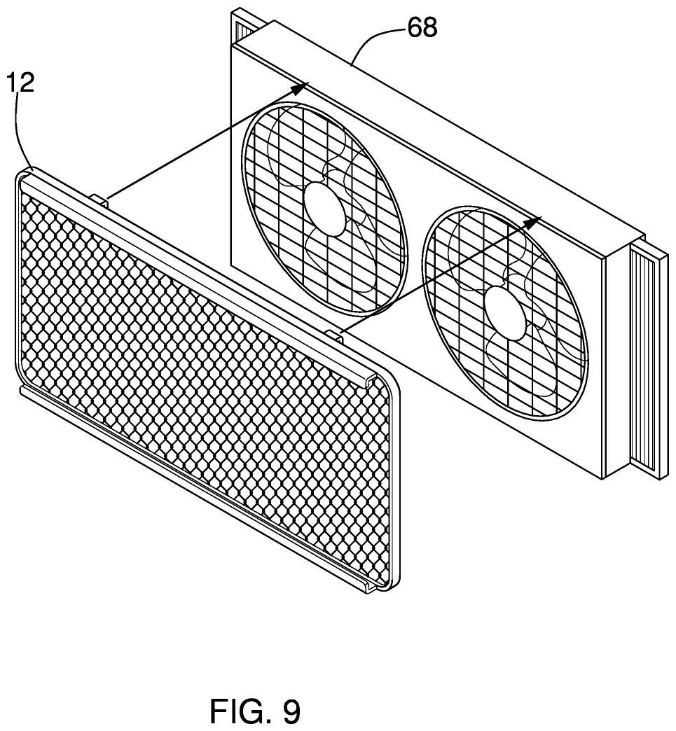

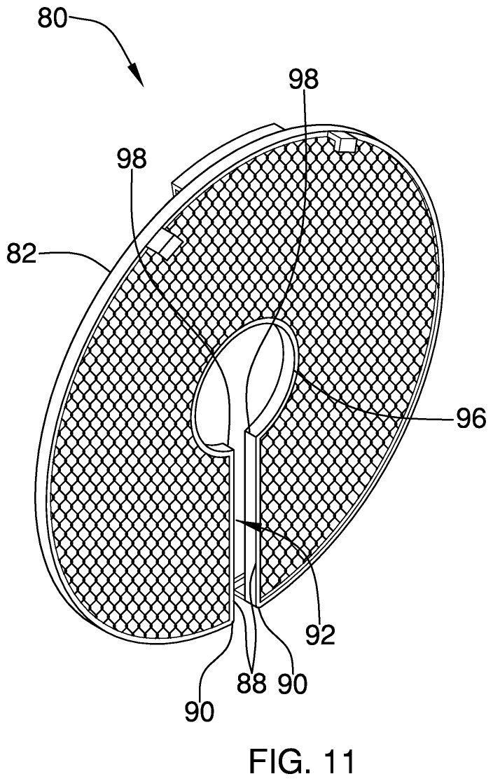

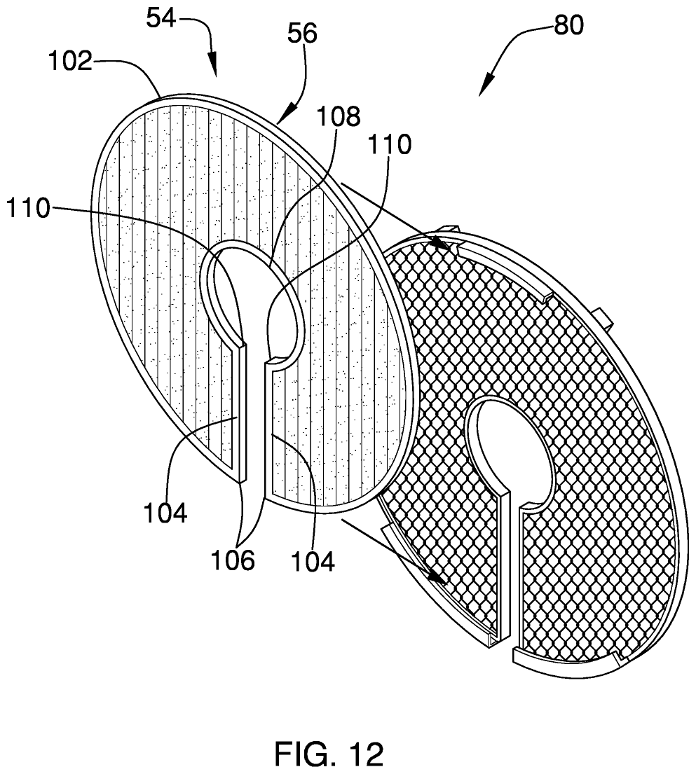

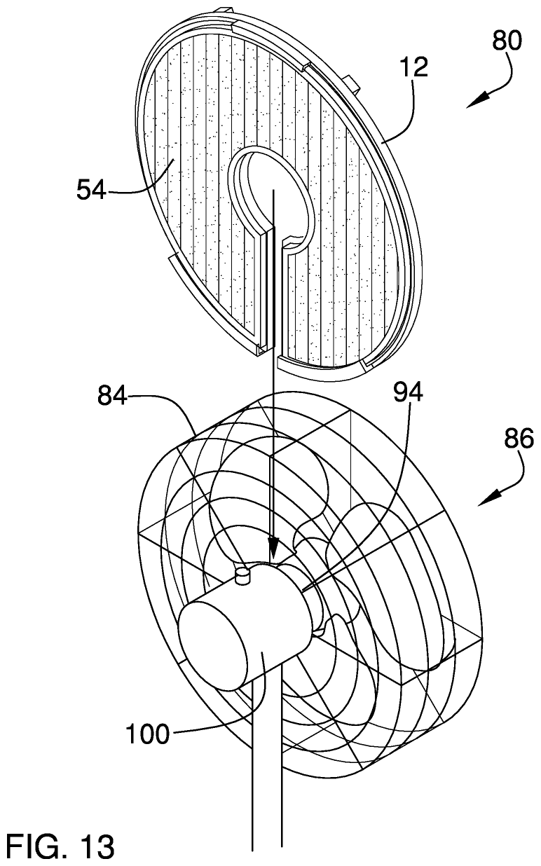

With reference now to the drawings, and in particular to FIGS. 1 through 13 thereof, a new air filter device embodying the principles and concepts of an embodiment of the disclosure and generally designated by the reference numeral 10 will be described.

As best illustrated in FIGS. 1 through 13, the fan mounted air filter device 10 generally comprises an electrostatic filter 12 that has a frame 14 and a screen 16 surrounded by the frame 14. The frame 14 has a plurality of intersecting sides 18 such that the frame 14 defines a rectangular shape thereby facilitating the frame 14 to conform to the shape of a box fan 19. In this way air blown by the box fan 19 passes over the screen 16 when the box fan 19 is turned on. The box fan 19 may be an electric box fan of any conventional design that is commonly employed for household applications. The screen 16 is comprised of an electrically charged material, including but not being limited to, steel or copper or conductive ceramic, thereby facilitating the screen 16 to electrostatically attract particles suspended in the air onto the screen 16 thereby removing the particles from the air. The frame 14 comprises a plurality of members 20 each perpendicularly oriented with a respective pair of the plurality of members 20 such that the frame 14 has a rectangular shape. Additionally, each of the plurality of members 20 has an inwardly facing surface 22 and a front surface 24 and a back surface 26. The screen 16 has a perimeter edge 28 that is attached to the inwardly facing surface 22 of each of the plurality of members 20 such that the screen 16 completely covers an opening 30 defined by the plurality of members 20.

A pair of brackets 32 is each attached to the frame 14 and each of the pair of brackets 32 is positioned on opposing ends of the frame 14 with respect to each other. Each of the pair of brackets 32 comprises a leg 34 extending away from the back surface 26 of a respective one of a top one of the plurality of members 36 of the frame 14 and a bottom one of the plurality of members 38 of the frame 14. The leg 34 of each of the pair of brackets 32 is elongated to extend along a substantial length of the respective top member 36 and bottom member 38. Additionally, each of the pair of brackets 32 includes a foot 40 which is perpendicularly oriented with the leg 34 such that the foot 40 of each of the pair of brackets 32 lies on a plane that is oriented parallel to the screen 16. The foot 40 of the bracket 32 that is positioned on the top member 36 is directed downwardly and the foot 40 of the bracket 32 that is positioned on the bottom member 38 is directed upwardly.

A pair of mounts 42 is provided and each of the pair of mounts 42 is attached to the frame 14. Each of the pair of mounts 42 is positioned on an opposing side of the frame 14 with respect to the pair of brackets 32. Additionally, each of the pair of mounts 42 releasably engages the box fan 19 for retaining the electrostatic filter 12 on the box fan 19. Each of the pair of mounts 42 comprises a leg 44 which extends away from the front surface 24 of the top member 36 of the frame 14. Each of the pair of mounts 42 includes a foot 46 that is perpendicularly oriented with the leg 44 of respective mount 42 such that the foot 40 of each of the pair of mounts 42 lies on a plane that is oriented parallel to the screen 16. Each of the pair of mounts 42 is spaced from a respective one of a first lateral one of the plurality of members 48 of the frame 14 and a second lateral one of the plurality of members 50 of the frame 14. The leg 34 of each of the pair of mounts 42 extends through a grate 52 of the box frame 14 such that the foot 40 of each of the pair of mounts 42 abuts the grate 52 thereby inhibiting the mounts 42 from being removed from the grate 52.

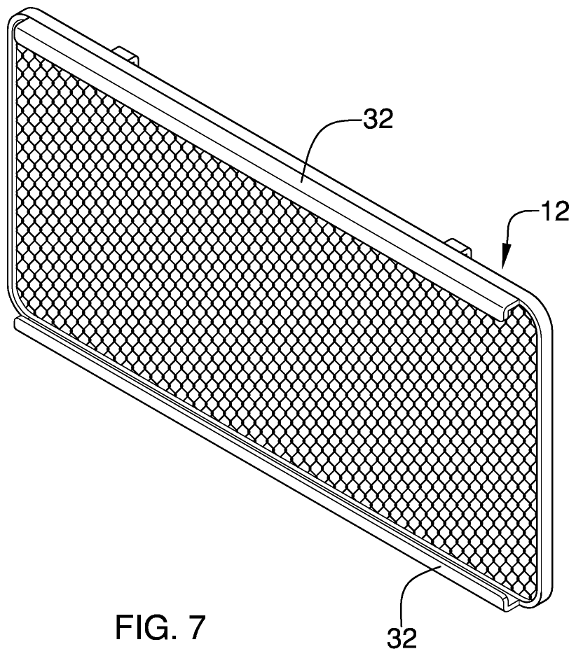

An air filter 54 is slidable into each of the pair of brackets 32 for securing the air filter 54 to the electrostatic filter 12. The air filter 54 is comprised of an air permeable material to filter particles from the air being blown by the box fan 19 which are too small to be captured by the electrostatic filter 12. The air filter 54 comprises a frame 56 that has a plurality of intersecting members 58 such that the frame 56 of the air filter 54 defines a rectangular shape. The air filter 54 includes a filtering element 60 which has an outer edge 62 that is bonded to an inwardly facing surface 64 of each of the plurality of intersecting members 58 of the frame 56 of the air filter 54 such that the filtering element 60 closes an opening 66 defined by the frame 56 of the air filter 54. As is shown in FIGS. 7-9, the frame 14 of the electrostatic filter 12 may be elongated between the first lateral member 48 and the second lateral member 50 of the frame 14 of the electrostatic filter 12 such that the frame 14 of the electrostatic filter 12 has a rectangular shape. In this way the electrostatic filter 12 can fit on a window fan 68, for example, or other fan that has a rectangular shape. Additionally, the frame 56 of the air filter 54 may be elongated to match the width of the frame 14 of the electrostatic filter 12.

The filtering element 60 includes a plurality of pleats 70 which each extend between a topmost one of the intersecting members 72 of the frame 56 of the air filter 54 and a bottommost one of the intersecting members 74 of the frame 56 of the air filter 54. Additionally, the plurality of pleats 70 is evenly spaced apart from each other and is distributed between a first sidelong one of the intersecting members 76 of the frame 56 of the air filter 54 and a second sidelong one of the intersecting members 78 of the frame 56 of the air filter 54. The topmost intersecting member 72 slides between the foot 40 of the bracket 32 on the top member 36 of the frame 14 of the electrostatic filter 12.

Additionally, the bottommost intersecting member 74 slides between the foot 40 of the bracket 32 on the bottom member 38 of the frame 14 of the electrostatic filter 12. The filtering element 60 may comprise a high efficiency particulate air filter or other type of filtering element that can capture particles which have a diameter of 0.3 μm or greater. Additionally, the filtering element 60 may include activated charcoal, or other type of odor absorbing media, to absorb odors in the air that is being blown by the box fan 19.

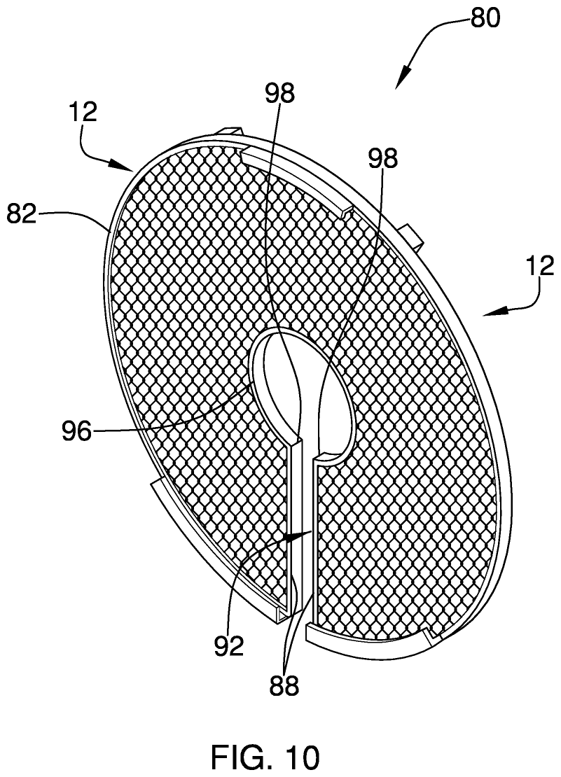

In an alternative embodiment 80 as is shown in FIGS. 10-13, the frame 14 of the electrostatic filter 12 has a first curved portion 82 which is continuously arcuate about a center of the frame 14 such that the first curved portion 82 defines a circular shape. In this way the frame 14 of the electrostatic filter 12 can conform to the shape of a cage 84 of an oscillating fan 86. The frame 14 of the electrostatic filter 12 has a pair of elongated portions 88 which each intersect a respective terminal end 90 of the first curved portion 82 and each of the pair of elongated portions 88 extends toward the center of the frame 14. The elongated portions 88 are spaced apart from each other to define a channel 92 in the electrostatic filter 12 which accommodates a drive shaft 94 of the oscillating fan 86.

Continuing in the alternative embodiment 80, the frame 14 of the electrostatic filter 12 has a second curved portion 96 which intersects a distal end 98 of each of the pair of elongated portions 88. The second curved portion 96 is continuously arcuate between the distal end 98 of each of the pair of elongated portion 88 such that the second curved portion 96 defines a circular shape that is concentric with the first curved portion 82. Furthermore, the second curved portion 96 accommodates a motor housing 100 of the oscillating fan 86. Additionally, the plurality of brackets 32 are distributed around the first curved portion 82.

Continuing in the alternative embodiment 80, the frame 56 of the air filter 54 has a primary curved portion 102 which is continuously arcuate about a center of the frame 14 such that the primary curved portion 102 defines a circular shape thereby facilitating the frame 56 of the air filter 54 to conform to the shape of the cage 86 of the oscillating fan 86. The frame 56 of the air filter 54 has a pair of elongated portions 104 which each intersect a respective terminal end 106 of the primary curved portion 102. Each of the pair of elongated portions 104 of the frame 56 of the air filter 54 extends toward the center of the frame 56 of the air filter 54. Additionally, the elongated portions 104 of the frame 56 of the air filter 54 are spaced apart from each other to define a channel 108 in the air filter 54 which accommodates the drive shaft 94 of the oscillating fan 86. The frame 56 of the air filter 54 has a secondary curved portion 108 which intersects a distal end 110 of each of the pair of elongated portions 104 of the frame 56 of the air filter 54. The secondary curved portion 108 is continuously arcuate between the distal end 110 of each of the pair of elongated portion 104 of the frame 56 of the air filter 54 such that the secondary curved portion 108 defines a circular shape that is concentric with the primary curved portion 102. In this way the secondary curved portion 108 accommodates the motor housing 100 of the oscillating fan. 86

In use, the electrostatic filter 12 is fitted to a back side 112 of the box fan 19 and the air filter 54 is slid into the brackets 32 on the electrostatic air filter 54. In this way the air filter 54 filters small particles from the air, as well as odors in the air, and the electrostatic filter 12 filters particles that are able to pass through the air filter 54. Thus, the air blown by the box fan 19 is nearly free from particles as well as being nearly free from odors. In this way an individual that suffers from allergies can enjoy relief from their allergies while enjoying the cooling effect of the box fan 19.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fan mounted air filter device for filtering air being blown by a fan thereby reducing allergic symptoms of occupants of a room being serviced by the fan, said device comprising:
an electrostatic filter having a frame and a screen surrounded by said frame, said frame having a plurality of intersecting sides such that said frame defines a rectangular shape thereby facilitating said frame to conform to the shape of a box fan wherein said screen is configured to have air blown by said box fan pass over said screen when said box fan is turned on, said screen being comprised of an electrically charged material wherein said screen is configured to attract particles suspended in the air onto said screen thereby removing the particles from the air;
a pair of brackets, each of said pair of brackets being attached to said frame, each of said pair of brackets being positioned on opposing ends of said frame with respect to each other;
a pair of mounts, each of said pair of mounts being attached to said frame, each of said pair of mounts being positioned on an opposing side of said frame with respect to said pair of brackets, each of said pair of mounts releasably engaging said box fan for retaining said electrostatic filter on said box fan; and
an air filter being slidable into each of said pair of brackets for securing said air filter to said electrostatic filter, said air filter being comprised of an air permeable material wherein said air filter is configured to filter particles from the air being blown by said box fan which are too small to be captured by said electrostatic filter.

2. The device according to claim 1, wherein:
said frame comprises a plurality of members each being perpendicularly oriented with a respective pair of said plurality of members such that said frame has a rectangular shape;
each of said plurality of members has an inwardly facing surface and a front surface and a back surface;
said screen has a perimeter edge;
said perimeter edge being attached to said inwardly facing surface of each of said plurality of members such that said screen completely covers an opening defined by said plurality of members;
each of said pair of brackets comprises a leg extending away from said back surface of a respective one of a top one of said plurality of members of said frame and a bottom one of said plurality of members of said frame;
said leg of each of said pair of brackets is elongated to extend along a substantial length of said respective top member and bottom member;
each of said pair of brackets includes a foot being perpendicularly oriented with said leg such that said foot of each of said pair of brackets lies on a plane being oriented parallel to said screen;
said foot of said bracket that is positioned on said top member is directed downwardly; and
said foot of said bracket that is positioned on said bottom member is directed upwardly.

3. The device according to claim 2, wherein:
each of said pair of mounts comprises a leg extending away from said front surface of said top member of said frame;
each of said pair of mounts includes a foot being perpendicularly oriented with said leg of respective mount such that said foot of each of said pair of mounts lies on a plane being oriented parallel to said screen;
each of said pair of mounts is spaced from a respective one of a first lateral one of said plurality of members of said frame and a second lateral one of said plurality of members of said frame; and
said leg of each of said pair of mounts extends through a grate of said box frame such that said foot of each of said pair of mounts abuts said grate thereby inhibiting said mounts from being removed from said grate.

4. The device according to claim 1, wherein:
each of said pair of brackets includes a leg and a foot;
said air filter comprises a frame having a plurality of intersecting members such that said frame of said air filter defines a rectangular shape;
said air filter includes a filtering element having an outer edge which is bonded to an inwardly facing surface of each of said plurality of intersecting members of said frame of said air filter such that said filtering element closes an opening defined by said frame of said air filter;
said filtering element includes a plurality of pleats which each extend between a topmost one of said intersecting members of said frame of said air filter and a bottommost one of said intersecting members of said frame of said air filter;
said plurality of pleats is evenly spaced apart from each other and is distributed between a first sidelong one of said intersecting members of said frame of said air filter and a second sidelong one of said intersecting members of said frame of said air filter;
said topmost intersecting member slides between said foot of said bracket on a top member of said frame of said electrostatic filter; and
said bottommost intersecting member slides between said foot of said bracket on a bottom member of said frame of said electrostatic filter.

6. A fan mounted air filter device for filtering air being blown by a fan thereby reducing allergic symptoms of occupants of a room being serviced by the fan, said device comprising:
an electrostatic filter having a frame and a screen surrounded by said frame, said frame having a plurality of intersecting sides such that said frame defines a rectangular shape thereby facilitating said frame to conform to the shape of a box fan wherein said screen is configured to have air blown by said box fan pass over said screen when said box fan is turned on, said screen being comprised of an electrically charged material wherein said screen is configured to attract particles suspended in the air onto said screen thereby removing the particles from the air, said frame comprising a plurality of members each being perpendicularly oriented with a respective pair of said plurality of members such that said frame has a rectangular shape, each of said plurality of members having an inwardly facing surface and a front surface and a back surface, said screen having a perimeter edge, said perimeter edge being attached to said inwardly facing surface of each of said plurality of members such that said screen completely covers an opening defined by said plurality of members;
a pair of brackets, each of said pair of brackets being attached to said frame, each of said pair of brackets being positioned on opposing ends of said frame with respect to each other, each of said pair of brackets comprising a leg extending away from said back surface of a respective one of a top one of said plurality of members of said frame and a bottom one of said plurality of members of said frame, said leg of each of said pair of brackets being elongated to extend along a substantial length of said respective top member and bottom member, each of said pair of brackets including a foot being perpendicularly oriented with said leg such that said foot of each of said pair of brackets lies on a plane being oriented parallel to said screen, said foot of said bracket that is positioned on said top member being directed downwardly, said foot of said bracket that is positioned on said bottom member being directed upwardly;
a pair of mounts, each of said pair of mounts being attached to said frame, each of said pair of mounts being positioned on an opposing side of said frame with respect to said pair of brackets, each of said pair of mounts releasably engaging said box fan for retaining said electrostatic filter on said box fan, each of said pair of mounts comprising a leg extending away from said front surface of said top member of said frame, each of said pair of mounts including a foot being perpendicularly oriented with said leg of respective mount such that said foot of each of said pair of mounts lies on a plane being oriented parallel to said screen, each of said pair of mounts being spaced from a respective one of a first lateral one of said plurality of members of said frame and a second lateral one of said plurality of members of said frame, said leg of each of said pair of mounts extending through a grate of said box frame such that said foot of each of said pair of mounts abuts said grate thereby inhibiting said mounts from being removed from said grate; and
an air filter being slidable into each of said pair of brackets for securing said air filter to said electrostatic filter, said air filter being comprised of an air permeable material wherein said air filter is configured to filter particles from the air being blown by said box fan which are too small to be captured by said electrostatic filter, said air filter comprising a frame having a plurality of intersecting members such that said frame of said air filter defines a rectangular shape, said air filter including a filtering element having an outer edge which is bonded to an inwardly facing surface of each of said plurality of intersecting members of said frame of said air filter such that said filtering element closes an opening defined by said frame of said air filter, said filtering element including a plurality of pleats which each extend between a topmost one of said intersecting members of said frame of said air filter and a bottommost one of said intersecting members of said frame of said air filter, said plurality of pleats being evenly spaced apart from each other and being distributed between a first sidelong one of said intersecting members of said frame of said air filter and a second sidelong one of said intersecting members of said frame of said air filter, said topmost intersecting member sliding between said foot of said bracket on said top member of said frame of said electrostatic filter, said bottommost intersecting member sliding between said foot of said bracket on said bottom member of said frame of said electrostatic filter.

7. The device according to claim 6, wherein:
said frame of said electrostatic filter has a first curved portion which is continuously arcuate about a center of said frame such that said first curved portion defines a circular shape such that said frame of said electrostatic filter conforms to the shape of a cage of an oscillating fan;
said frame of said electrostatic filter has a pair of elongated portions which each intersect a respective terminal end of said first curved portion, each of said pair of elongated portions extending toward said center of said frame, said pair of elongated portions being spaced apart from each other to define a channel in said electrostatic filter which accommodates a drive shaft of said oscillating fan;
said frame of said electrostatic filter has a second curved portion which intersects a distal end of each of said pair of elongated portions, said second curved portion being continuously arcuate between said distal end of each of said pair of elongated portion such that said second curved portion defines a circular shape that is concentric with said first curved portion such that said second curved portion accommodates a motor housing of said oscillating fan; and
said plurality of brackets are distributed around said first curved portion.

8. The device according to claim 7, wherein:
said frame of said air filter has a primary curved portion which is continuously arcuate about a center of said frame such that said primary curved portion defines a circular shape such that said frame of said air filter conforms to the shape of a cage of an oscillating fan;
said frame of said air filter has a pair of elongated portions which each intersect a respective terminal end of said primary curved portion, each of said pair of elongated portions of said frame of said air filter extending toward said center of said frame of said air filter, said pair of elongated portions of said frame of said air filter being spaced apart from each other to define a channel in said air filter which accommodates a drive shaft of said oscillating fan; and
said frame of said air filter has a secondary curved portion which intersects a distal end of each of said pair of elongated portions of said frame of said air filter, said secondary curved portion being continuously arcuate between said distal end of each of said pair of elongated portion of said frame of said air filter such that said secondary curved portion defines a circular shape that is concentric with said primary curved portion such that said secondary curved portion accommodates a motor housing of said oscillating fan.
